(19) United States
(12) Patent Application Publication
(10) Pub. No.: US 2022/0068508 A1
(43) Pub. Date: Mar. 3, 2022

(54) METHOD AND APPARATUS FOR CONTROLLING FRESHNESS OF SENSOR INFORMATION

(71) Applicant: Electronics and telecommunications research institute, Daejeon (KR)

(72) Inventors: Taehyoung SHIM, Sejong-si (KR); Sung Hei KIM, Daejeon (KR); Yoon Young AN, Sejong-si (KR)

(73) Assignee: ELECTRONICS AND TELECOMMUNICATIONS RESEARCH INSTITUTE, Daejeon (KR)

(21) Appl. No.: 17/206,074

(22) Filed: Mar. 18, 2021

(30) Foreign Application Priority Data
Aug. 28, 2020 (KR) 10-2020-0109380

(51) Int. Cl. G16Y 40/35; G16Y 40/10; H04L 29/08

(52) U.S. Cl. CPC G16Y 40/35; H04L 67/12; G16Y 40/10

(57) ABSTRACT

A method and apparatus for controlling freshness of sensor information is provided. The method includes receiving a plurality of sets of sensor information, calculating the freshness of each or integrated freshness of the sets of sensor information, generating a sensor information message by controlling freshness of the sets of sensor information and combining the sets of sensor information, and transmitting the sensor information message to an information user.

### CROSS-REFERENCE TO RELATED APPLICATION(S)

This application claims the priority benefit of Korean Patent Application No. 10-2020-0109380 filed on Aug. 28, 2020, in the Korean Intellectual Property Office, the disclosure of which is incorporated herein by reference for all purposes.

### BACKGROUND

### 1. Field

One or more example embodiments relate to a method and apparatus for controlling to freshness of sensor information.

### 2. Description of Related Art

A system may include a sensor, a slave device, a master device, and a data server. Sensor information of the sensor may be transmitted to the data server through a master-slave device relationship.

The master device may be designed to collect, combine, and convert sets of information. The master device may request the slave device connected to the sensor for the sensor information, receive the sensor information from the slave device, convert combined sensor information according to the purpose of use, and transmit a result obtained through the converting to the data server.

### SUMMARY

An aspect provides a technology for controlling the freshness of sensor information to remove unnecessary sensor information and timely transmit only useful sensor information.

However, example embodiments to be described hereinafter may not be limited to the foregoing technology, and there may be other technical aspects.

According to an example embodiment, there is provided a method of controlling freshness of sensor information, the method including receiving a plurality of sets of sensor information, generating a sensor information message by controlling freshness of each of the sets of sensor information and combining the sets of sensor information, and transmitting the sensor information message to an information user.

An element that determines the freshness may include at least one of a change in time, a generation frequency, or a change in value or state of sensor information.

The generating may include calculating the freshness of each of the sets of sensor information, calculating integrated freshness of the sets of sensor information, and generating the sensor information message based on the integrated freshness.

The calculating of the freshness may include calculating the freshness of each of the sets of sensor information based on a change in time, a generation frequency, and a change in value or state of sensor information.

The calculating of the integrated freshness may include removing less fresh sensor information from the sets of sensor information using the freshness of the sets of sensor information, and calculating the integrated freshness based on freshness of remaining sets of sensor information except the removed sensor information.

The method may further include controlling a generation period of less fresh sensor information among the sets of sensor information based on the freshness of the sets of sensor information.

The controlling may include controlling a request timestamp of the less fresh sensor information with a device that transmits the less fresh sensor information.

The controlling may include controlling a publish period of the less fresh sensor information with the device that transmits the less fresh sensor information.

According to another example embodiment, there is provided an apparatus for controlling freshness of sensor information, the apparatus including a memory configured to store therein at least one instruction, and a processor configured to execute the instruction. When the instruction is executed, the processor may receive a plurality of sets of sensor information, generate a sensor information message by controlling freshness of each of the sets of sensor information and combining the sets of sensor information, and transmit the sensor information message to an information user.

An element that determines the freshness may include at least one of a change in time, a generation frequency, or a change in value or state of sensor information.

The processor may calculate the freshness of each of the sets of sensor information, calculate integrated freshness of the sets of sensor information by controlling the freshness of each of the sets of sensor information, and generate the sensor information message based on the integrated freshness.

The processor may calculate the freshness of each of the sets of sensor information based on a change in time, a generation frequency, and a change in value or state of sensor information.

The processor may remove less fresh sensor information from the sets of sensor information using the freshness of the sets of sensor information, and calculate the integrated freshness based on freshness of remaining sets of sensor information except the removed sensor information.

The processor may control a generation period of less fresh sensor information among the sets of sensor information based on the freshness of the sets of sensor information.

The processor may control a request timestamp of the less fresh sensor information with a device that transmits the less fresh sensor information.

The processor may control a publish period of the less fresh sensor information with the device that transmits the less fresh sensor information.

According to still another example embodiment, there is provided a method of controlling freshness of sensor information, the method including receiving a plurality of sets of sensor information, controlling freshness of each of the sets of sensor information by removing less fresh sensor information from the sets of sensor information, generating a sensor information message by combining remaining sets of sensor information except the removed sensor information, and transmitting the sensor information message to an information user.

The method may further include controlling a generation period of the less fresh sensor information.

The controlling may include controlling a request timestamp of the less fresh sensor information with a device that transmits the less fresh sensor information, or controlling a publish period of the less fresh sensor information with the device that transmits the less fresh sensor information.

According to yet another example embodiment, there is provided a method of controlling freshness of sensor information, the method including receiving a plurality of sets of sensor information, removing less fresh sensor information from the sets of sensor information and calculating integrated freshness using freshness of remaining sets of sensor information except the removed sensor information, generating a sensor information message by combining the remaining sets of sensor information based on the integrated freshness, and transmitting the sensor information message to an information user.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an example of a system for transmitting sensor information according to an example embodiment;

FIG. 2 is a diagram illustrating an example of a method of transmitting information between a master device and a slave device that are illustrated in FIG. 1;

FIG. 3 is a diagram illustrating an example of a change in the freshness of sensor information according to an example embodiment;

FIG. 4 is a diagram illustrating another example of a change in the freshness of sensor information according to an example embodiment;

FIG. 5 is a diagram illustrating an example of improving the freshness of sensor information according to an example embodiment;

FIG. 6 is a flowchart illustrating an example of a method of transmitting information to an information user by a master device based on the freshness of sensor information according to an example embodiment;

FIG. 7 is a diagram illustrating an example of an apparatus for controlling the freshness of sensor information according to an example embodiment; and

FIGS. 8 and 9 are diagrams illustrating examples of transmission using the apparatus for controlling the freshness of sensor information illustrated in FIG. 7.

### DETAILED DESCRIPTION

Hereinafter, some examples will be described in detail with reference to the accompanying drawings. However, various alterations and modifications may be made to the examples. Here, the examples are not construed as limited to the disclosure and should be understood to include all changes, equivalents, and replacements within the idea and the technical scope of the disclosure.

The terminology used herein is for the purpose of describing particular examples only and is not to be limiting of the examples. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Throughout the specification, when a component is described as being “connected to,” or “coupled to” another component, it may be directly “connected to,” or “coupled to” the other component, or there may be one or more other components intervening therebetween.

In contrast, when an element is described as being “directly connected to,” or “directly coupled to” another element, there can be no other elements intervening therebetween.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

When describing the examples with reference to the accompanying drawings, like reference numerals refer to like constituent elements and a repeated description related thereto will be omitted. In the description of examples, detailed description of well-known related structures or functions will be omitted when it is deemed that such description will cause ambiguous interpretation of the present disclosure.

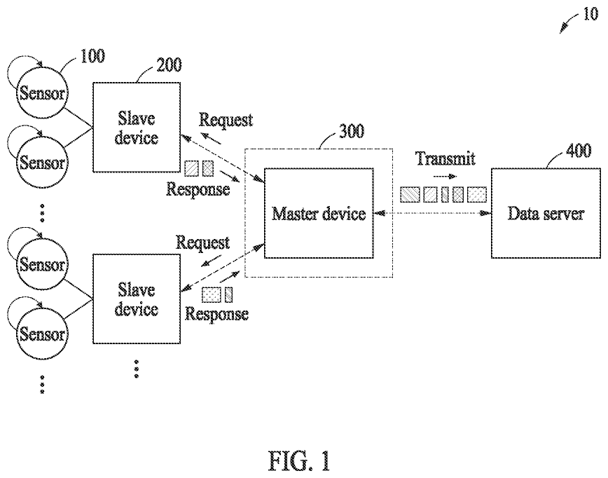

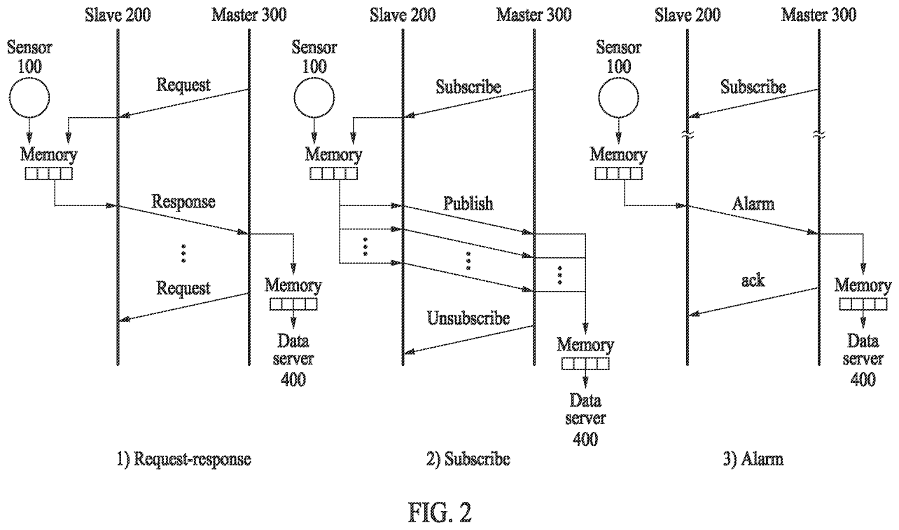

FIG. 1 is a diagram illustrating an example of a system for transmitting sensor information according to an example embodiment. FIG. 2 is a diagram illustrating an example of a method of transmitting information between a master device and a slave device that are illustrated in FIG. 1.

A system 10 for transmitting sensor information, hereinafter simply a sensor information transmitting system 10, includes at least one sensor 100, at least one slave device 200, a master device 300, and a data server 400. Here, sensor information of the sensor 100 may be transmitted to the data server 400 through a relationship between the master device 300 and the slave device 200. The data server 400 may be an information user that demands the information.

The sensor 100 may generate the sensor information and transmit the generated sensor information to the slave device 200. The slave device 200 may be connected to the sensor 100 which is one or more sensors to receive the sensor information from the sensor 100 connected thereto. The slave device 200 may collect the sensor information from the sensor 100 on a periodic basis and store the collected sensor information. The slave device 200 may transmit the collected sensor information to the master device 300 in response to a request for the sensor information.

The master device 300 may request each of the slave device 200 which is one or more slave devices for the sensor information, and receive the sensor information from each of the slave device 200. That is, the master device 300 may collect a plurality of sets of sensor information from the one or more slave devices.

The master device 300 may generate a sensor information message by combining or integrating the sets of sensor information received from the slave device 200, convert the generated sensor information message according to a purpose, and then transmit the sensor information message obtained through the converting to the data server 400. That is, the master device 300 may collect, combine, and covert the sensor information. The master device 300 may be used according to at least one purpose, for example, for converting other communication protocols, recombining data structures through information collection, being a broker of a network between a provider and a user of information, and being various application service providers.

A process of transmitting the sensor information of the sensor 100 from the slave device 200 to the data server 400 through the master device 300 includes 1) a request-response step, 2) a subscribe step, and 3) an alarm step.

1) The Request-Response Step

In this step, the master device 300 requests the slave device 200, and then the slave device 200 responds to the master device 300.

The master device 300 may request the slave device 200 for sensor information. In response to the request for the sensor information, the slave device 200 may transmit, to the master device 300, the sensor information that is received from the sensor 100 and then stored. The master device 300 may combine or integrate the sensor information received from the slave device 200 which is one or more slave devices, convert a combined or integrated message, and transmit the message obtained through the converting to the data server 400.

2) The Subscribe Step

In this step, the master device 300 receives, from the slave device 200, sensor information that is updated periodically.

The master device 300 may request the slave device 200 for subscription to the sensor information. In response to the request for the subscription, the slave device 200 may transmit (or publish), to the master device 300, sensor information that is updated based on a predetermined period when it is requested based on the period. The slave device 200 may update the sensor information that is received from the sensor 100 and then stored therein based on the period.

The master device 300 may also request the slave device 200 for unsubscription to the sensor information.

3) The Alarm Step

This step is to notify the master device 300 of an alarm of the sensor 100.

The sensor 100 may transmit an alarm signal to the slave device 200. In response to the alarm signal, the slave device 200 may transmit alarm information to the master device 300 without a request. The master device 300 may generate an acknowledgement (or ack) in response to the alarm information and transmit the generated ack to the slave device 200.

The master device 300 may perform operations to control the steps 1), 2), and 3) described above. For example, the master device 300 may control a request timestamp of sensor information at which the sensor information is requested to the slave device 200. The master device 300 may control a publish period of the sensor information to be updated. The master device 300 may also control the transmission to the data server 400 when receiving the alarm information from the slave device 200.

To transmit the combined sensor information from the master device 300 to the data server 400 through the foregoing steps 1), 2), and 3), the master device 300 may control the freshness of a plurality of sets of sensor information collected from the slave device 200 which is one or more slave devices and combine only sets of fresh sensor information among the sets of sensor information to generate a sensor information message. Here, the master device 300 may control a generation period of sensor information that is relatively less fresh among the sets of sensor information. The master device 300 may control the slave device 200 that transmits such less fresh sensor information among the sets of sensor information. For example, the master device 300 may control a request timestamp of the sensor information at which the sensor information is requested to the slave device 200, or control a publish period of the sensor information in which the sensor information is updated.

The freshness of sensor information may be defined as an index of a value of the sensor information based on a change in time for which information (e.g., real-time information) is generated by an information producer such as the sensor 100 and transmitted to an information user such as the slave device 200, the master device 300, or the data server 400 and then consumed therein. That is, fresh sensor information may refer to one that has a value for practical use without being decayed.

That is, the master device 300 may remove unnecessary sensor information, and timely transmit only useful fresh sensor information to the information user, for example, the data server 400.

Hereinafter, the freshness of sensor information will be described in greater detail, and how the master device 300 generates a sensor information message by controlling the freshness of sensor information and combining sets of sensor information, and transmits the generated sensor information message will be described in detail.

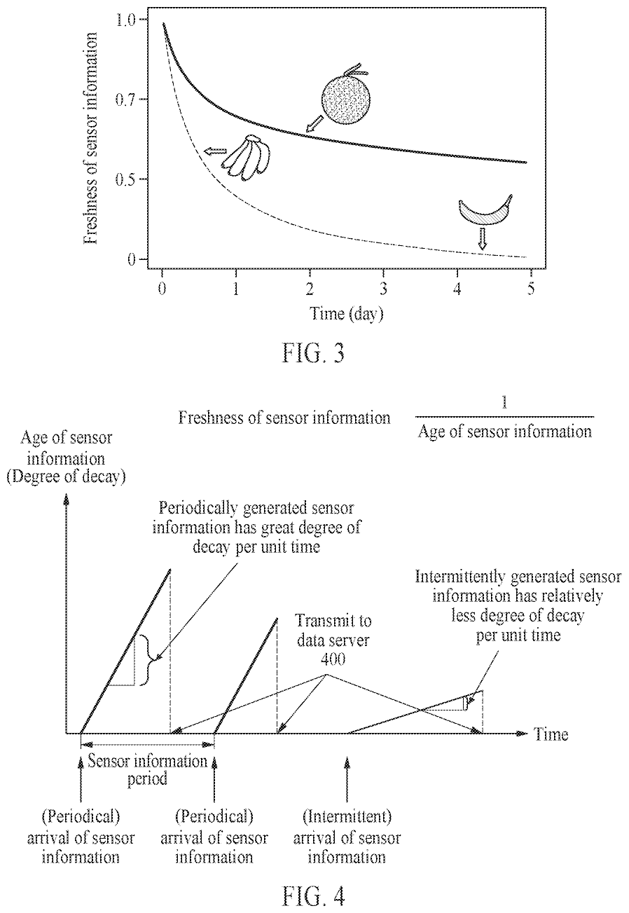

FIG. 3 is a diagram illustrating an example of a change in the freshness of sensor information according to an example embodiment.

The freshness of sensor information may be affected by a change in time. As time elapses, a degree of decay of the sensor information increases, and the freshness of the sensor information may decrease gradually. An example of the freshness of sensor information that changes over time is illustrated as the freshness of fruit that changes over time in FIG. 3. For example, the freshness of a banana that is left at room temperature for less than one day may be greater than the freshness of the banana that is left at room temperature for over four days. However, the freshness of a melon is fresher for over four days at room temperature in contrast with the change in the freshness of the banana. That is, all of fruits varies in the degree of decay over time.

Similarly, for sensor information that is continuously updated over time, as sensor information is newly generated, the usefulness of sensor information generated previously may decrease and the freshness thereof may decrease accordingly. That is, the freshness of sensor information may be inversely proportional to an elapsed time (or an age of sensor information) from a time when the information is generated by a producer (e.g., a sensor) to a time when the information is consumed by a user (e.g., a data server). In addition, the degree of change in the freshness of each sensor information may be different as time elapses due to its characteristics or priorities.

FIG. 4 is a diagram illustrating another example of a change in the freshness of sensor information according to an example embodiment.

The freshness of sensor information may also be affected by a generation period of sensor information. FIG. 4 illustrates a change in the freshness of sensor information based on a generation period of the sensor information.

For sensor information that is updated based on a relatively short period, sensor information is frequently replaced with newly generated sensor information, and thus the freshness may decrease more rapidly. This is because periodically generated sensor information may have a great degree of decay per unit time, and thus the freshness thereof may decrease more rapidly.

In contrast, for sensor information such as alarm information (e.g., a device error) that is generated or occurs intermittently, the freshness thereof may need to be maintained although time elapses, and thus the decrease in the freshness based on an elapsed time may be relatively low. This is because such sensor information that occurs intermittently may have a relatively less degree of decay per unit time.

As described above with reference to FIGS. 3 and 4, sensor information may have a degree of decay that increases as time elapses, and the value of the information may thus decrease gradually. Thus, the master device 300 may need to improve the freshness of sensor information to maximize the freshness.

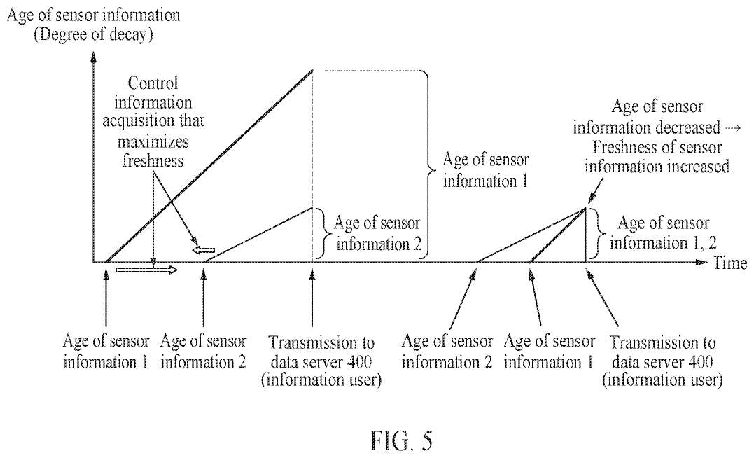

FIG. 5 is a diagram illustrating an example of improving the freshness of sensor information according to an example embodiment.

FIG. 5 illustrates a change in the age of two sets of sensor information 1 and 2 that arrive at different points in time, and how the freshness is improved by controlling the acquisition of sensor information.

Referring to FIG. 5, sensor information 1 arrived first at the master device 300 may be relatively older in age compared to sensor information 2, at a point in time at which combined information is transmitted from the master device 300 to the data server 400. Here, by controlling, by the master device 300, a generation period of sensor information for the slave device 200 in order to postpone an arrival time of sensor information 1 and advance an arrival time of sensor information 2, it is possible to maintain the freshness of both sensor information 1 and 2. That is, by controlling the acquisition of sensor information between the master device 300 and the slave device 200, and thereby matching the ages of sensor information 1 and 2 at a point in time at which sensor information is consumed (or transmitted to the data server 400), it is possible to improve the freshness of sensor information combined by the master device 300.

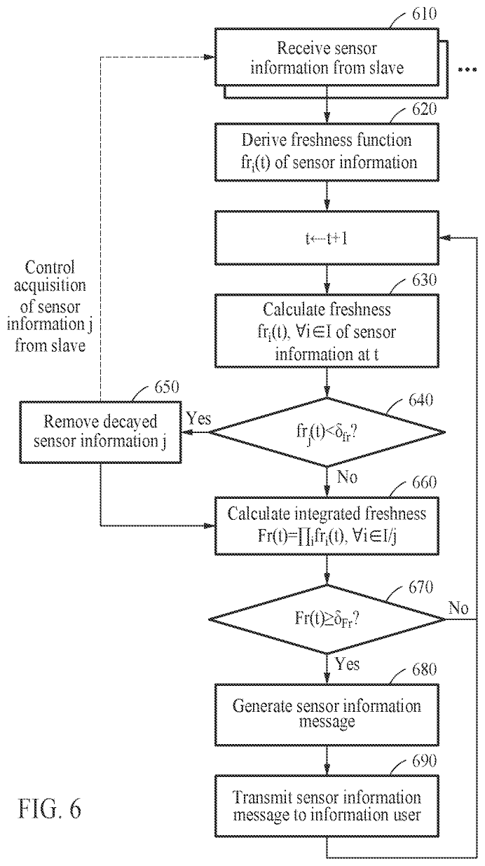

FIG. 6 is a flowchart illustrating an example of a method of transmitting information to an information user by a master device based on the freshness of sensor information according to an example embodiment.

The freshness of sensor information may be determined based on change determining elements. Table 1 below indicates such change determining elements that change the freshness of sensor information. The change determining elements that change the sensor information may include a change in value or state of the sensor information in addition to a change in time of the sensor information and a generation period of the sensor information that are described above with reference to FIGS. 3 and 4. The magnitude of the change in value or state of the sensor information may reflect therein the value or usefulness of the sensor information and may thus affect the freshness of the sensor information.

1) A Change in Time

A change in time of sensor information may represent an elapsed time after the sensor information is generated. The freshness may gradually decrease as the degree of decay of the sensor information increases as time elapses.

2) A Change in Value or State

When a change in the value or state of sensor information is small, the master device 300 may determine that a value of the sensor information is not great based on a change in time. Thus, a change in a decrease in the freshness of the sensor information may be great. Conversely, when the change in the value or state of the sensor information is great, the master device 300 may determine the sensor information to be important sensor information even when time elapses. Thus, the change in the decrease in the freshness of the sensor information may be relatively small, and thus the freshness may be relatively great.

3) A Generation Frequency

The freshness of periodic sensor information with a relatively great generation frequency may not be relatively great due to the influence of newly updated information. Conversely, for sensor information with a relatively less generation frequency, for example, a device error that occurs intermittently, the freshness may need to be maintained based on a change in time.

TABLE 1

| | Change in decrease in freshness dfr(t)/dt | |
|---|---|---|
| Sensor information changing | Large gradient | Small gradient |
| elements | dfr(t)/dt > δ_{fr} | dfr(t)/dt < δ_{fr} |
| Time change Δt | Freshness gradually decreases based | |
| | on a change in time | |
| Large change in value or state | | O |
| Δs > δ_{Δs} | | |
| Large generation frequency, | O | |
| f > δ_{f} | | |

Signs or symbols indicated in Table 1 above are as follows.

Δt: A change in time after generation of sensor information

As: A change in value or state, which may be represented as [sᵢ(t)−s̅ᵢ̅], for example. In this example, sᵢ(t) denotes a state or a value of sensor information i at a time t, and s̅ᵢ̅denotes an average state or value, or a state or a value of the sensor information i in a recent general state.

f: A generation frequency of sensor information. Periodically generated sensor information may have a relatively great generation frequency, while non-periodically generated alarm information may have a relatively small generation frequency.

dfr(t)/dt: A degree of a change in the freshness of sensor information based on time. In general, the freshness may decrease as time elapses. However, a degree of the decrease in the freshness based on time may vary depending on a degree (or a gradient) of the change in the decrease.

δ_{Δs}, δ_{f}, δ_{fr}: Thresholds based on respective sensor information changing elements.

Referring to Table 1 above, the freshness may be a value that gradually decreases as time elapses. As a change in a value (or a state) of sensor information is great, a gradient by which the freshness decreases may be small. As a generation frequency increases, a freshness decrease rate based on time may gradually increase.

The master device 300 may use the freshness of sensor information as an index for determining a value of information. For example, the master device 300 may generate a sensor information message by controlling the freshness of sensor information and combining only sets of fresh sensor information as described above with reference to FIG. 6, and transmit the generated sensor information message to an information user. A detailed description will follow hereinafter.

In operation 610, the master device 300 receives sensor information from each slave device 200. That is, the master device 300 may receive a plurality of sets of sensor information.

In operation 620, the master device 300 derives a freshness function of the sensor information. For example, the master device 300 may derive a time-based freshness function frᵢ(t|Δs, f) based on a state change As and a generation frequency f of sensor information i. age, denotes a sensor information age function representing a degree of decay of the sensor information i, which is inversely proportional to the freshness function frᵢ. For example, age, may be modeled as represented below.

ageᵢ(t)=αᵢ(t−t₀), t≥t₀ [Equation 1]

ageᵢ may gradually increase as time elapses from a time t₀ at which sensor information is generated. In Equation 1, αᵢ denotes a value representing a degree of a change in decay based on an elapsed time, which is inversely proportional to the state change Δs of information for each sensor information and proportional to the generation frequency f A value of the sensor information age change rate a, may be modeled as represented below.

$${α}_{i} = \frac{{f}_{i}}{{r}_{slave} \cdot ⌊ {s}_{i} ( t ) - \overline{{s}_{i}} ⌋} ∝ \frac{F}{Δ s} , {α}_{i} > 0 \qquad [ Equation 2 ]$$

In Equation 2, f denotes a generation frequency of sensor information i, and rₛₗₐᵥₑ a master-slave data (transmission) rate. sᵢ(t) denotes a state or a value of the sensor information i at a time t. s̅ᵢ̅ denotes an average state or value, or a state or a value of the sensor information i in a recent general state.

The degree of change in decay a, denotes a ratio of the number of sets of information generated while a value or state of a single set of sensor information changes. For example, in a case in which there is a great number of sets of information generated while a state changes from On to Off when a sensor has single sensor information as On/Off, age, of the sensor information i may be decayed within a rapid period of time. However, when a single message such as an alarm message is generated, a change in age, of the sensor information i based on time may be small such that the information is not decayed.

Through such calculations above, the freshness of the sensor information i may be derived as represented by Equation 3.

$$f {r}_{i} ( t ) = \frac{1}{{age}_{i} ( t )} = \frac{1}{{α}_{i} ( t - {t}_{0} )} \qquad [ Equation 3 ]$$

In operation 630, the master device 300 calculates the freshness frᵢ(t), ∀i∈l of each sensor information at each time t.

In operations 640 and 650, the master device 300 compares the freshness of the sets of sensor information to a threshold value (e.g., frⱼ(t)≤δ_{fr}, j∈I), and remove sensor information j with less freshness from among the sets of sensor information. The master device 300 may control a generation period of the sensor information j to improve the freshness. For example, the master device 300 may control a request timestamp of the sensor information j from the slave device 200 that transmits the sensor information j, or control a publish period of the sensor information j.

In operation 660, the master device 300 calculates an integrated freshness Fr(t) based on the freshness frᵢ(t), ∀i∈I of each sensor information. The integrated freshness may be calculated as represented by Fr(t)=Πᵢ[wᵢ·frᵢ(t)], ∀i∈I, where wᵢ represents the weighting factor of sensor information i, and Σᵢwᵢ=1, wᵢ∈[0, 1].

In operation 670, the master device 300 compares the integrated freshness Fr(t) to a threshold value δ_{Fr} (e.g., Fr(t)≥δ_{Fr}to minimize a transmission delay of highly fresh information. The master device 300 may compare the integrated freshness Fr(t) and the threshold value δ_{Fr} to minimize the transmission delay of the highly fresh information and minimize the transmission of information that is unnecessary and less fresh for an information user. For example, when highly fresh sensor information is predicted to be received at a time t+1, or when the integrated freshness is predicted to increase at the time t+1, the master device 300 may skip transmitting the integrated information message to information user at time t and perform again the operations starting from operation 630.

In operations 680 and 690, when there is no expectation of further improvement in the integrated freshness Fr(t), the master device 300 may generate a sensor information message by combining only sets of fresh sensor information among the sets of sensor information, and transmit the generated sensor information message to the data server 400 which is an information user.

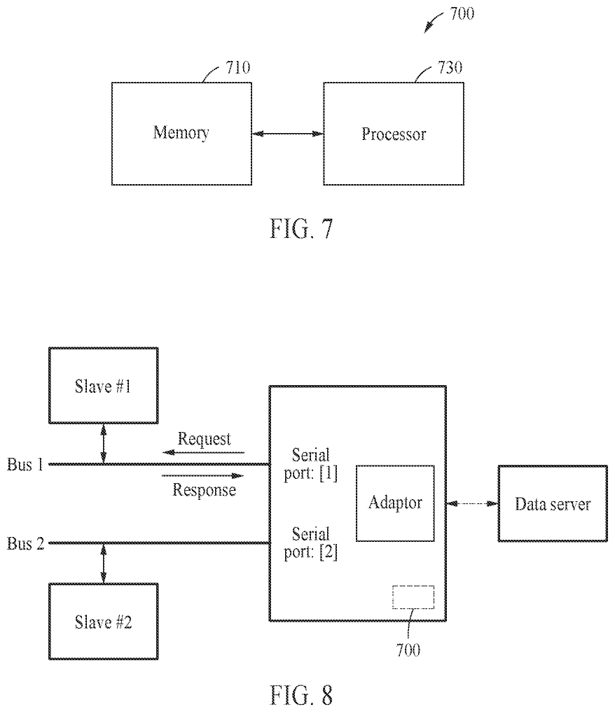

FIG. 7 is a diagram illustrating an example of an apparatus for controlling the freshness of sensor information according to an example embodiment. The apparatus for controlling the freshness of sensor information will be hereinafter referred to as a sensor information freshness controlling apparatus for simplicity.

Referring to FIG. 7, a sensor information freshness controlling apparatus 700 may be embodied by or in the master device 300 described above with reference to FIGS. 1 through 6. The sensor information freshness controlling apparatus 700 may obtain a change in the freshness of sensor information over time based on collected sensor information, combine the collected sensor information based on integrated freshness of the sensor information, and transmit the combined sensor information to an information user (or an information consumer).

The sensor information freshness controlling apparatus 700 includes a memory 710 and a processor 730.

The memory 710 may store instructions (or a program) executable by the processor 730. For example, the instructions may include instructions for performing operations of the processor 730 and/or operations of each component of the processor 730.

The processor 730 may process data stored in the memory 710. The processor 730 may execute a computer-readable code (e.g., software) stored in the memory 710 and instructions induced by the processor 730.

The processor 730 may be a data processing device embodied by hardware having a circuit in a physical structure to execute desired operations. For example, the desired operations may include a code or instructions included in a program.

The data processing device embodied by hardware may include, for example, a microprocessor, a central processing unit (CPU), a processor core, a multi-core processor, a multiprocessor, an application-specific integrated circuit (ASIC), and a field-programmable gate array (FPGA).

The processor 730 may control the freshness of sensor information and transmit information to an information user. For a more detailed description of the controlling of the freshness of the sensor information and the transmitting of the information to the information user, reference may be made to the descriptions of the operations of the master device 300 provided above with reference to FIGS. 1 through 6. Thus, a more detailed and repeated description thereof will be omitted here for brevity.

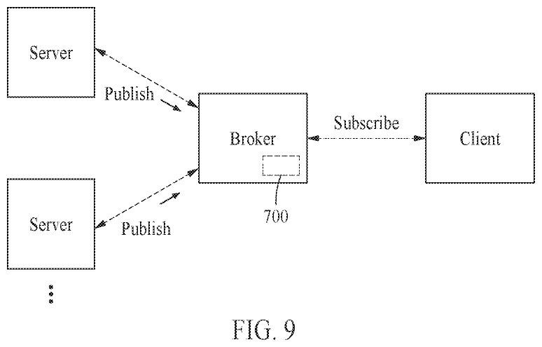

FIGS. 8 and 9 are diagrams illustrating examples of transmission using the sensor information freshness controlling apparatus 700 illustrated in FIG. 7.

FIG. 8 illustrates a serial communication-based system, and FIG. 9 illustrates a subscribe-publish based Internet of things (IoT) system. The sensor information freshness controlling apparatus 700 of FIG. 7 may be embodied as an adaptor which is a device configured to convert the serial communication-based sensor information transmission to an Ethernet as illustrated in FIG. 8, or as a subscribe-publish based broker of FIG. 9. Alternatively, the sensor information freshness controlling apparatus 700 may be embodied thereby.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of controlling freshness of sensor information, comprising:
receiving a plurality of sets of sensor information;
generating a sensor information message by controlling freshness of each of the sets of sensor information and combining the sets of sensor information; and
transmitting the sensor information message to an information user.

2. The method of claim 1, wherein an element that determines the freshness includes at least one of a change in time, a generation frequency, or a change in value or state of sensor information.

3. The method of claim 1, wherein the generating comprises:
calculating the freshness of each of the sets of sensor information;
calculating integrated freshness of the sets of sensor information; and
generating the sensor information message based on the integrated freshness.

4. The method of claim 3, wherein the calculating of the freshness comprises:
calculating the freshness of each of the sets of sensor information based on a change in time, a generation frequency, and a change in value or state of sensor information.

5. The method of claim 3, wherein the calculating of the integrated freshness comprises:
removing less fresh sensor information from the sets of sensor information using the freshness of the sets of sensor information; and
calculating the integrated freshness based on freshness of remaining sets of sensor information except the removed sensor information.

6. The method of claim 1, further comprising:
controlling a generation period of less fresh sensor information among the sets of sensor information based on the freshness of the sets of sensor information.

7. The method of claim 6, wherein the controlling comprises:
controlling a request timestamp of the less fresh sensor information with a device that transmits the less fresh sensor information.

8. The method of claim 6, wherein the controlling comprises:
controlling a publish period of the less fresh sensor information with a device that transmits the less fresh sensor information.

9. An apparatus for controlling freshness of sensor information, comprising:
a memory configured to store therein at least one instruction; and
a processor configured to execute the instruction,
wherein, when the instruction is executed, the processor is configured to:
receive a plurality of sets of sensor information;
generate a sensor information message by controlling freshness of each of the sets of sensor information and combining the sets of sensor information; and
transmit the sensor information message to an information user.

10. The apparatus of claim 9, wherein an element that determines the freshness includes at least one of a change in time, a generation frequency, or a change in value or state of sensor information.

11. The apparatus of claim 9, wherein the processor is configured to:
calculate the freshness of each of the sets of sensor information;
calculate integrated freshness of the sets of sensor information by controlling the freshness of each of the sets of sensor information; and
generate the sensor information message based on the integrated freshness.

12. The apparatus of claim 11, wherein the processor is configured to:
calculate the freshness of each of the sets of sensor information based on a change in time, a generation frequency, and a change in value or state of sensor information.

13. The apparatus of claim 11, wherein the processor is configured to:
remove less fresh sensor information from the sets of sensor information using the freshness of the sets of sensor information; and
calculate the integrated freshness based on freshness of remaining sets of sensor information except the removed sensor information.

14. The apparatus of claim 9, wherein the processor is configured to:
control a generation period of less fresh sensor information among the sets of sensor information based on the freshness of the sets of sensor information.

15. The apparatus of claim 14, wherein the processor is configured to:
control a request timestamp of the less fresh sensor information with a device that transmits the less fresh sensor information.

16. The apparatus of claim 14, wherein the processor is configured to:
control a publish period of the less fresh sensor information with a device that transmits the less fresh sensor information.

17. A method of controlling freshness of sensor information, comprising:
receiving a plurality of sets of sensor information;
controlling freshness of each of the sets of sensor information by removing less fresh sensor information from the sets of sensor information;
generating a sensor information message by combining remaining sets of sensor information except the removed sensor information; and
transmitting the sensor information message to an information user.

18. The method of claim 17, further comprising:
controlling a generation period of the less fresh sensor information.

19. The method of claim 18, wherein the controlling comprises:
controlling a request timestamp of the less fresh sensor information with a device that transmits the less fresh sensor information; or
controlling a publish period of the less fresh sensor information with the device that transmits the less fresh sensor information.
